(19) United States
(12) Patent Application Publication
(10) Pub. No.: US 2025/0364005 A1
(43) Pub. Date: Nov. 27, 2025

(54) AUDIO ENHANCEMENT METHOD AND APPARATUS

(71) Applicant: HARMAN INTERNATIONAL INDUSTRIES, INCORPORATED, Stamford, CT (US)

(72) Inventors: Xin WANG, Shenzhen (CN); Yadi WANG, Shenzhen (CN); Ka Man Raymond LUI, Shenzhen (CN)

(21) Appl. No.: 19/187,113

(22) Filed: Apr. 23, 2025

(30) Foreign Application Priority Data
May 24, 2024 (CN) 202410652646.1

(51) Int. Cl. G10L 21/0364

(52) U.S. Cl. CPC G10L 21/0364

(57) ABSTRACT

The present disclosure provides an audio enhancement method, an audio enhancement apparatus and device, a computer-readable storage medium, and a computer program product. The audio enhancement method includes: receiving an input audio; processing at least a part of the input audio using at least one of a plurality of audio enhancement modes to generate at least one processed audio; determining a target audio enhancement mode from the plurality of audio enhancement modes based at least in part on the at least one processed audio; and processing the input audio using the target audio enhancement mode to generate an enhanced audio, and outputting the enhanced audio.

### CROSS-REFERENCE TO RELATED APPLICATIONS

This application claims priority benefit of Application No. CN 202410652646.1, titled “AUDIO ENHANCEMENT METHOD AND APPARATUS,” and filed May 24, 2024. The subject matter of this related application is hereby incorporated by reference herein in its entirety.

### BACKGROUND

### Field of the Various Embodiments

The present disclosure relates to the field of audio processing, and more particularly, to an audio enhancement method, an audio enhancement apparatus and device, a computer-readable storage medium, and a computer program product.

### Description of the Related Art

Generally speaking, different individuals have different degrees of sensitivity to sounds at different frequencies, so the same audio may produce different hearing effects for different individuals. Therefore, in some scenarios, customized audio enhancement for an individual may be necessary to enhance sounds within certain frequency ranges to which the individual is not sensitive. In addition, due to injuries, genetics, aging and other reasons, a considerable number of people will face varying degrees of hearing impairment, making it difficult for them to hear clear sounds when talking to people, listening to music, or listening to TV or radio programs. As the trend of global population aging is accelerating, the proportion of people with hearing impairments continues to rise, leading to a growing demand for hearing assistance or hearing enhancement products.

### SUMMARY

In view of the problems mentioned above, the present disclosure provides an audio enhancement method, an audio enhancement apparatus and device, a computer-readable storage medium and a computer program product.

According to at least one aspect of the present disclosure, an audio enhancement method is provided, including: receiving an input audio; processing at least a part of the input audio using at least one of a plurality of audio enhancement modes to generate at least one processed audio; determining a target audio enhancement mode from the plurality of audio enhancement modes based at least in part on the at least one processed audio; and processing the input audio using the target audio enhancement mode to generate an enhanced audio, and outputting the enhanced audio.

In one or more embodiments of the present disclosure, each of the plurality of audio enhancement modes is used to adjust one or more of loudness, tone, timbre and clarity of the input audio.

In one or more embodiments of the present disclosure, the plurality of audio enhancement modes are predetermined by: determining a plurality of hearing impairment categories based on hearing test data, where the plurality of hearing impairment categories are determined based on hearing responses for one or more of loudness, tone, timbre, and clarity; determining one or more acoustic adjustment parameters for each of the plurality of hearing impairment categories by analyzing the hearing responses, the acoustic adjustment parameters being used for adjusting one or more of loudness, tone, timbre, and clarity; and determining an audio enhancement mode corresponding to each of the plurality of hearing impairment categories based on the one or more acoustic adjustment parameters.

In one or more embodiments of the present disclosure, determining the target audio enhancement mode from the plurality of audio enhancement modes based at least in part on the at least one processed audio includes: determining an audio enhancement mode corresponding to a processed audio with the best audio quality among the at least one processed audio as the target audio enhancement mode.

In one or more embodiments of the present disclosure, determining the target audio enhancement mode from the plurality of audio enhancement modes based at least in part on the at least one processed audio includes: comparing each of the at least one processed audio with a predetermined condition; and determining an audio enhancement mode corresponding to a processed audio satisfying the predetermined condition among the at least one processed audio as the target audio enhancement mode.

In one or more embodiments of the present disclosure, determining the target audio enhancement mode from the plurality of audio enhancement modes based at least in part on the at least one processed audio includes: acquiring an object feature of an object receiving the enhanced audio; and selecting an audio enhancement mode that matches the object feature from the plurality of audio enhancement modes as the target audio enhancement mode.

In one or more embodiments of the present disclosure, the object feature includes one or more of age, gender, hearing ability, personal preference, working environment, and living environment of the object receiving the enhanced audio.

According to at least one aspect of the present disclosure, an audio enhancement apparatus is provided, the apparatus including: a receiving unit configured to receive an input audio; a processing unit configured to process at least a part of the input audio using at least one of a plurality of audio enhancement modes to generate at least one processed audio, determine a target audio enhancement mode from the plurality of audio enhancement modes based at least in part on the at least one processed audio, and process the input audio using the target audio enhancement mode to generate an enhanced audio; and an output unit configured to output the enhanced audio.

According to at least one aspect of the present disclosure, an audio enhancement apparatus is provided, including: one or more processors; and one or more memories having computer-readable instructions stored therein, the computer-readable instructions, when executed by the one or more processors, cause the one or more processors to perform the method as described in any one of the above embodiments.

According to at least one aspect of the present disclosure, a computer-readable storage medium is provided, having computer-readable instructions stored thereon, the computer-readable instructions, when executed by a processor, cause the processor to perform the method as described in any one of the above embodiments.

According to at least one aspect of the present disclosure, a computer program product is provided, including computer-readable instructions therein, the computer-readable instructions, when executed by a processor, cause the processor to perform the method as described in any one of the above embodiments of the present disclosure.

According to the audio enhancement method, audio enhancement apparatus and device, computer-readable storage medium and computer program product of the various aspects above of the present disclosure, it is possible to objectively divide a plurality of hearing impairment categories through big data analysis of the hearing test data to more objectively and truly reflect the hearing loss features of the hearing-impaired population. Thereafter, a plurality of audio enhancement modes are specifically formulated for each hearing impairment category. In this way, when receiving an input audio, an applicable target audio enhancement mode can be determined from the plurality of audio enhancement modes to enhance the input audio, making it possible to better compensate for the hearing defects of users with hearing impairments and provide users with a better auditory experience.

### BRIEF DESCRIPTION OF THE DRAWINGS

The above and other objects, features and advantages of the embodiments of the present disclosure will become more apparent through a more detailed description of the embodiments of the present disclosure in conjunction with the accompanying drawings. The accompanying drawings are used to provide further understanding of the embodiments of the present disclosure and constitute a part of the specification. They are used to explain the present disclosure together with the embodiments of the present disclosure and do not constitute a limitation of the present disclosure. In the accompanying drawings, like reference numerals generally represent like components or steps.

FIG. 1 illustrates a flowchart of an audio enhancement method according to one or more embodiments of the present disclosure;

FIG. 2 illustrates a flowchart of determining a target audio enhancement mode according to an example of one or more embodiments of the present disclosure;

FIG. 3 illustrates a flowchart of a method for determining a plurality of audio enhancement modes according to an example of one or more embodiments of the present disclosure;

FIG. 4 illustrates a schematic structural view of an audio enhancement apparatus according to one or more embodiments of the present disclosure; and

FIG. 5 illustrates a user interface according to an example of one or more embodiments of the present disclosure.

### DETAILED DESCRIPTION

The technical solutions in the embodiments of the present disclosure will be clearly and completely described below in conjunction with the accompanying drawings in the embodiments of the present disclosure. Obviously, the described embodiments are only some of the embodiments of the present disclosure, rather than all the embodiments. Based on the embodiments of the present disclosure, all other embodiments obtained by those of ordinary skill in the art without making creative effort shall fall within the scope of protection of the present disclosure.

As illustrated in the embodiments and the claims of the present disclosure, unless otherwise indicated clearly in the context, the words “a,” “an,” “a kind of,” and/or “the”, and the like do not refer specifically to the singular, but may also include the plural. The words “first,” “second,” and the like used in the present disclosure do not indicate any order, quantity or importance, but are only used to distinguish different components. Similarly, the words “including,” “comprising,” and the like mean that the element or object preceding the words includes the elements or objects listed after the words and equivalents thereof, but do not exclude other elements or objects. The words “connected,” “coupled,” and the like are not limited to physical or mechanical connections, but may include electrical connections, whether direct or indirect.

In the embodiments of the present application, the term “module” or “unit” refers to a computer program or a segment of a computer program that has a predetermined function and works together with other related parts to achieve a predetermined goal, and can be implemented entirely or in part by using software, hardware (such as a processing circuit or memory) or a combination thereof. Likewise, one processor (or a plurality of processors or memories) can be used to implement one or more modules or units. Furthermore, each module or unit may be a part of an integral module or unit that includes the function of the module or unit.

Furthermore, flowcharts are used in the present disclosure to illustrate operations performed by a system according to embodiments of the present disclosure. It should be understood that the preceding or following operations are not necessarily performed precisely in sequence. Instead, various steps may be processed in a reverse order or concurrently. Meanwhile, it is also possible to add other operations to these processes or to remove a step or steps from these processes.

As people age, their hearing deteriorates, causing a large number of elderly people to face hearing problems, affecting their normal life and communication. There are also many young people who suffer from hearing impairment due to long-term earphone abuse, special working environment, illness, disability and other factors. In terms of sound frequency, hearing impairment may include high-frequency hearing impairment, low-frequency hearing impairment, mixed high- and low-frequency hearing impairment, etc. High-frequency hearing impairment is more common among the elderly. Patients have reduced hearing ability for high-frequency sounds, such as insensitivity to the voices of women and children, inability to hear birds singing or doorbells, and inability to discern sounds in noisy environments. Low-frequency hearing impairment, such as “reverse slope” (or ascending) hearing impairment, is difficulty in hearing low-frequency sounds. Patients usually have no problems with face-to-face conversations, but are insensitive to telephone communications, male voices, thunder, machine operating sounds, etc., which mainly transmit low-frequency and mid-frequency information. Mixed high- and low-frequency hearing impairment is difficulty in hearing both high-frequency and low-frequency sounds.

In traditional audio enhancement methods for hearing impairment, acoustic engineers use audio tuning tools to subjectively adjust acoustic parameters to enhance sound effects; or, hearing-impaired people need to undergo subjective hearing tests before using audio enhancement devices such as hearing aids, and the parameters of the audio enhancement devices are adjusted accordingly. The present disclosure provides an audio enhancement method, and an audio enhancement apparatus and device, which can provide a plurality of audio enhancement modes determined based on objective analysis of big data for user selection, so that the user can select the most suitable audio enhancement mode for audio enhancement. The audio enhancement method, apparatus and device provided by the present disclosure can be applied to terminals such as mobile phones, tablet computers, desktops, smart wearable devices, earphones, stereos, televisions, etc., which is not particularly limited by embodiments of the present disclosure, and can effectively solve the hearing difficulties of people with hearing impairments such as the elderly.

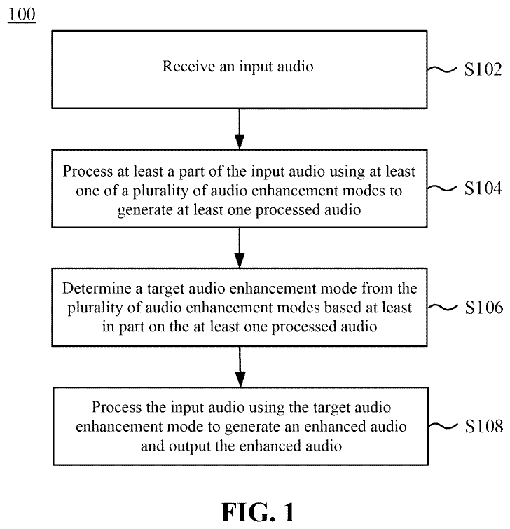

The audio enhancement method according to the present disclosure is described below with reference to FIG. 1. FIG. 1 illustrates a flowchart of an audio enhancement method 100 according to one or more embodiments of the present disclosure. As described above, the audio enhancement method 100 can be implemented on terminals such as mobile phones, tablet computers, desktop computers, smart wearable devices, earphones, stereos, televisions, etc., which is not particularly limited by embodiments of the present disclosure.

As shown in FIG. 1, in step S102, an input audio is received. The input audio may be any audio to be enhanced, such as an audio to be output by a mobile phone, a tablet computer, a desktop computer, a smart wearable device, earphones, a stereo, a television, etc., which is not particularly limited by embodiments of the present disclosure. In this case, audio processing debugging can be performed directly based on a part of the input audio to determine a target audio enhancement mode, and then audio enhancement processing is performed on other parts of the input audio and further audios that are subsequently input using the target audio enhancement mode. Alternatively, the input audio may be a short segment of test audio output by the terminal, so that the user can perform audio processing debugging based on the test audio to determine the target audio enhancement mode, and perform audio enhancement processing on the audio that is subsequently input using the target audio enhancement mode.

In step S104, at least a part of the input audio is processed using at least one of a plurality of audio enhancement modes to generate at least one processed audio. Each of the plurality of audio enhancement modes can be used to process one or more of the parameters, such as loudness, tone, timbre, and clarity, of the input audio. As is well known, sound has three elements: loudness, tone and timbre. Loudness indicates the strength of the sound, which can correspond to the amplitude of the sound source. Tone indicates the highness of the sound, which depends on the frequency of the vibration of the sound source. The higher the frequency, the higher the tone. Typically, the frequency range that the human ear can hear is approximately from 20 Hz to 20 kHz. Timbre indicates the unique properties of different sound sources and is determined by the harmonic spectrum and envelope of the sound waveform. In the present disclosure, the clarity of audio may indicate the intelligibility of the audio in a noisy environment, or more specifically, may indicate the frequency components and energy distribution of the background noise in the audio.

In an example of the present disclosure, among the plurality of audio enhancement modes, the first audio enhancement mode can, for example, adjust the loudness of the input audio, the second audio enhancement mode can, for example, adjust the tone of the input audio, the third audio enhancement mode can, for example, adjust the timbre of the input audio, and the fourth audio enhancement mode can, for example, adjust the clarity of the input audio, and so on. In another example of the present disclosure, among the plurality of audio enhancement modes, the first audio enhancement mode can, for example, adjust both the loudness and tone of the input audio, the second audio enhancement mode can, for example, adjust both the tone and timber of the input audio, and the third audio enhancement mode can, for example, adjust the loudness, tone, timbre and clarity of the input audio, and so on. In yet another example of the present disclosure, among the plurality of audio enhancement modes, the first audio enhancement mode can, for example, perform audio enhancement processing for the features of high-frequency hearing impairment, the second audio enhancement mode can, for example, perform audio enhancement processing for the features of low-frequency hearing impairment, and the third audio enhancement mode can, for example, perform audio enhancement processing for the features of mixed high- and low-frequency hearing impairment.

It should be noted that the above description is merely an example and does not constitute any limitation of the present disclosure. Each of the plurality of audio enhancement modes can adjust any one or more parameters of the input audio, which is not particularly limited by the embodiments of the present disclosure.

As mentioned above, most of the existing audio enhancement methods for hearing impairment are subjective, so their audio enhancement effects are also subjective and unstable. In the present disclosure, a plurality of audio enhancement modes can be obtained based on objective analysis of big data. Specifically, hearing tests can be performed on a large number of hearing-impaired people to collect hearing test data, and a plurality of hearing impairment categories can be determined based on the large amount of collected hearing test data, and an audio enhancement mode corresponding to each of the plurality of hearing impairment categories can be specifically determined. The method for determining a plurality of audio enhancement modes according to one or more embodiments of the present disclosure will be described in further detail below.

Returning to step S104, when the input audio is an audio to be enhanced output by the terminal, a part of the input audio can be processed using at least one of the plurality of audio enhancement modes to generate at least one processed audio. On the other hand, when the input audio is a test audio output by the terminal, the entire test audio can be processed using at least one of the plurality of audio enhancement modes to generate at least one processed audio. In an example, the input audio can be processed using each of the plurality of audio enhancement modes to generate a plurality of processed audios. In another example, one or more of the plurality of audio enhancement modes can be selected to process the input audio to generate at least one processed audio.

In step S106, a target audio enhancement mode can be determined from the plurality of audio enhancement modes based at least in part on the at least one processed audio, where the target audio enhancement mode refers to an audio enhancement mode to be used for audio enhancement processing.

According to an example of an embodiment of the present disclosure, the audio qualities of various processed audios can be compared, and an audio enhancement mode corresponding to a processed audio with the best audio quality can be determined as the target audio enhancement mode. The processed audio with the best audio quality can be determined, for example, through subjective evaluation by a user, or through calculation and comparison of objective evaluation parameters of the various processed audios, which is not particularly limited by the embodiments of the present disclosure. For example, the objective evaluation parameters may be the frequency distribution, amplitude, signal-to-noise ratio (SNR), peak-to-average power ratio (PAPR), short-term objective intelligibility (STOI), etc., or any combination thereof, of the processed audio.

According to another example of an embodiment of the present disclosure, each of the at least one processed audio can be compared with a predetermined condition, and the audio enhancement mode corresponding to the processed audio satisfying the predetermined condition can be determined as the target audio enhancement mode. For example, one or more thresholds can be preset, such as an amplitude threshold, a frequency distribution related threshold, an SNR threshold, a PANR threshold, an STOI threshold, etc., and when a corresponding parameter of a processed audio is greater than the one or more thresholds, the mode corresponding to the processed audio is determined as the target audio enhancement mode. It should be noted that the description of the threshold here is only an example and does not constitute any limitation of the present disclosure. Any other relevant threshold may also be selected according to actual design or application requirements.

According to yet another embodiment of the present disclosure, determining the target audio enhancement mode from the plurality of audio enhancement modes based at least in part on the at least one processed audio may further include acquiring an object feature of an object receiving the enhanced audio; and selecting an audio enhancement mode that matches the object feature from the plurality of audio enhancement modes as the target audio enhancement mode. The object receiving the enhanced audio refers to the object that listens to the output enhanced audio, and the object feature may include one or more of the age, gender, hearing ability, personal preference, working environment, living environment, etc., of the object receiving the enhanced audio. The object feature may be acquired from a user input, or determined by a terminal that applies the audio enhancement method of the present disclosure, through, for example, facial detection, voiceprint recognition, or other means, which is not particularly limited by the embodiments of the present disclosure. For example, when it is determined that the object receiving the enhanced audio is an elderly person, since the elderly usually have high-frequency hearing impairment, the audio enhancement mode for high-frequency hearing impairment can be determined as the target audio enhancement mode to enhance the high-frequency portion of the input audio.

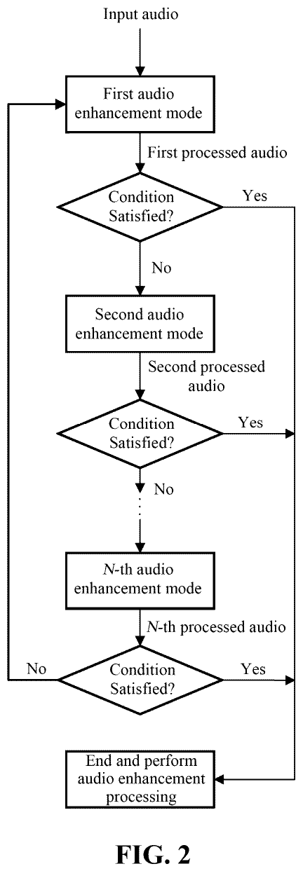

FIG. 2 illustrates a flowchart of determining a target audio enhancement mode according to an example of one or more embodiments of the present disclosure. In the example of FIG. 2, debugging processing is performed on at least a part of the input audio by sequentially using the first audio enhancement mode, the second audio enhancement mode, . . . , and the Nth audio enhancement mode (N is a positive integer greater than 1), and after each audio processing, it is determined whether the processed audio satisfies a predetermined condition. When it is determined that the processed audio obtained using a certain audio enhancement mode satisfies the predetermined condition, the debugging processing is terminated and the audio enhancement mode is determined as the target audio enhancement mode. Thereafter, audio enhancement processing can be performed on the input audio and other audio that is input subsequently using the target audio enhancement mode. For example, as shown in FIG. 2, when the first processed audio obtained by processing the input audio with the first audio enhancement mode satisfies the predetermined condition, the debugging processing can be terminated and the first audio enhancement mode can be determined as the target audio enhancement mode; otherwise, the input audio is continued to be processed using the second audio enhancement mode to obtain a second processed audio, and it is determined whether the second processed audio satisfies the predetermined condition. The above processing and determination are performed sequentially until the N-th audio enhancement mode. If the N-th processed audio still does not satisfy the predetermined condition, the first audio enhancement mode can be returned to. In this case, for example, some or all parameters of the first to N-th audio enhancement modes can be adjusted (e.g., all parameters may be increased by 10% or decreased by 10%), and the above steps can be repeated. Alternatively, the process can be terminated directly at this point. It should be noted that the flowchart shown in FIG. 2 is merely an example of an implementation and does not constitute any limitation of the present disclosure.

In step S108, the input audio is processed using the target audio enhancement mode to generate an enhanced audio and the enhanced audio is output. As described above, after the target audio enhancement mode is determined, audio processing can be performed on the input audio and further audios that are subsequently input using the target audio enhancement mode, and the generated enhanced audio can be output, for example, to a speaker or other audio playback devices to convey it to the user. The enhanced audio is an audio that is obtained by adjusting one or more of the loudness, tone, timbre, clarity, etc., of the input audio using a target audio enhancement mode for a specific hearing impairment category, so that users who belong to the hearing impairment category or have similar hearing impairment problems can clearly hear the input audio.

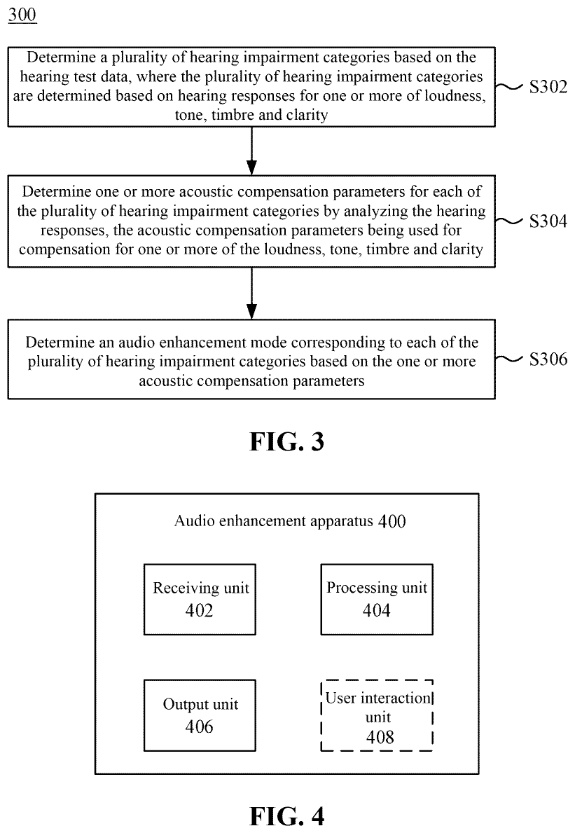

A method for determining a plurality of audio enhancement modes according to one or more embodiments of the present disclosure is described below with reference to FIG. 3. FIG. 3 illustrates a flowchart 300 of a method for determining a plurality of audio enhancement modes according to an example of one or more embodiments of the present disclosure.

As shown in FIG. 3, in step S302, a plurality of hearing impairment categories are determined based on the hearing test data. The plurality of hearing impairment categories can be determined based on hearing responses for one or more of the loudness, tone, timbre and clarity. Specifically, the hearing test data can be collected by performing hearing tests on a large number of hearing-impaired people. For example, test audios with different parameters, such as loudnesses, tones, timbres, clarities, etc., can be played to the test subjects, and the hearing responses of the test subjects to the test audios can be recorded as the hearing test data. Based on the large-scale hearing test data collected, a plurality of hearing impairment categories can be determined. For example, cluster analysis can be performed on the hearing test data using a clustering algorithm to divide data samples with similar features into the same cluster and dissimilar data samples into different clusters, thereby dividing the hearing test data into different categories. These different categories of hearing test data correspond to different hearing impairment categories. For example, a first hearing impairment category may be insensitive to an audio with lower loudness and higher tone, a second hearing impairment category may be insensitive to audio with higher tone and lower clarity, and so on.

In step S304, one or more acoustic adjustment parameters can be determined for each of the plurality of hearing impairment categories by analyzing the recorded hearing responses. The acoustic adjustment parameters are used for adjusting one or more of the loudness, tone, timbre and clarity. For example, in the case where the first hearing impairment category is insensitive to an audio with lower loudness and higher tone, a plurality of acoustic adjustment parameters for adjusting the loudness and tone can be determined to, for example, increase the loudness of the input audio and reduce the frequency of the high-frequency portion of the input audio (thereby reducing the tone). As another example, in the case where the second hearing impairment category is insensitive to an audio with higher tone and lower clarity, a plurality of acoustic adjustment parameters for adjusting the tone and clarity can be determined, for example, to reduce the frequency of the high-frequency portion of the input audio (thereby reducing the tone) and increase the signal-to-noise ratio of the input audio.

In step S306, an audio enhancement mode corresponding to each of the plurality of hearing impairment categories is determined based on the one or more determined acoustic adjustment parameters, so as to obtain a plurality of audio enhancement modes. Still taking the examples in steps S302 and S304 as an example, the audio enhancement mode corresponding to the first hearing impairment category can be used to adjust the loudness and frequency of the input audio, for example, to increase the loudness of the input audio by 20% and reduce the frequency of the high-frequency portion by 20%, where the high-frequency portion can be determined based on a predetermined frequency threshold; the audio enhancement mode corresponding to the second hearing impairment category can be used to adjust the frequency and clarity of the input audio, for example, to reduce the frequency of the high-frequency portion of the input audio by 20% and, for example, to increase the filtering strength or the number of times of filtering processing, and so forth.

It should be noted that the examples in the above steps are only for the convenience of explanation and do not constitute any limitation of the present disclosure. Any other appropriate method may also be used to determine the hearing impairment category based on the hearing test data, and further determine the acoustic adjustment parameters and the corresponding audio enhancement mode. By objectively dividing a plurality of hearing impairment categories through big data analysis of the hearing test data, the hearing loss features of the hearing-impaired population can more objectively and truly reflected, so that the audio enhancement mode specifically formulated accordingly for each hearing impairment category can better compensate for the hearing defects of the hearing-impaired population.

The audio enhancement method according to one or more embodiments of the present disclosure is described above. By using this audio enhancement method, it is possible to objectively divide a plurality of hearing impairment categories through big data analysis of the hearing test data and formulate a plurality of audio enhancement modes specifically for them. Therefore, when the input audio is enhanced using the target audio enhancement mode determined from the plurality of audio enhancement modes, the hearing defects of users with hearing impairments can be better compensated for, thereby providing users with a better auditory experience.

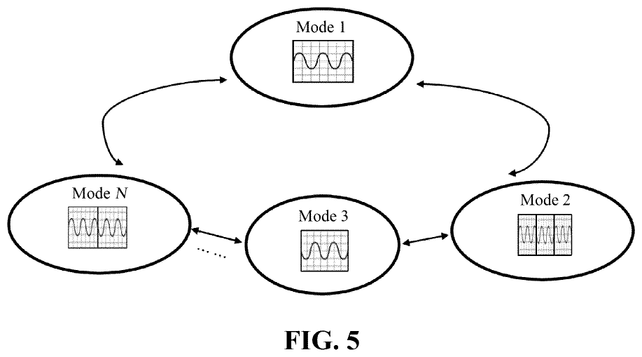

The audio enhancement apparatus according to one or more embodiments of the present disclosure will be described below with reference to FIG. 4. FIG. 4 illustrates a schematic structural view of an audio enhancement apparatus 400 according to one or more embodiments of the present disclosure. As shown in FIG. 4, the audio enhancement apparatus 400 may include a receiving unit 402, a processing unit 404, and an output unit 406. In addition to the three units, the audio enhancement apparatus 400 may further include other related components, but since these components are not related to the present disclosure, a detailed description of specifics thereof is omitted here. In addition, since the details of some functions of the audio enhancement apparatus 400 are similar to the details of the steps of the audio enhancement method 100 described with reference to FIG. 1, the repeated description of some contents is omitted here for the sake of brevity. The audio enhancement apparatus may be an independent apparatus, such as earphones or a stereo for audio enhancement; or, the audio enhancement apparatus may also be included in other terminals or devices with audio enhancement functions, such as a mobile phone, a tablet computer, a desktop computer, a smart wearable device, a stereo, a television, etc., which is not particularly limited by embodiments of the present disclosure.

The receiving unit 402 is configured to receive an input audio. The input audio may be any audio to be enhanced, such as an audio output by a mobile phone, a tablet computer, a desktop computer, a smart wearable device, earphones, a stereo, a television, etc., which is not particularly limited by embodiments of the present disclosure. In this case, audio processing debugging can be performed directly based on a part of the input audio to determine a target audio enhancement mode, and then audio enhancement processing is performed on other parts of the input audio and further audios that are subsequently input using the target audio enhancement mode. Alternatively, the input audio may be a short segment of test audio output by the terminal, so that the user can perform audio processing debugging based on the test audio to determine the target audio enhancement mode, and perform audio enhancement processing on the audio that is subsequently input using the target audio enhancement mode.

The processing unit 404 is configured to process at least a part of the input audio using at least one of the plurality of audio enhancement modes to generate at least one processed audio. Each of the plurality of audio enhancement modes can be used to process one or more of the parameters, such as the loudness, tone, timbre, and clarity, of the input audio, which is not particularly limited by embodiments of the present disclosure. As is well known, sound has three elements: loudness, tone and timbre. Loudness indicates the strength of the sound, which can correspond to the amplitude of the sound source. Tone indicates the highness of the sound, which depends on the frequency of the vibration of the sound source. The higher the frequency, the higher the tone. Typically, the frequency range that the human ear can hear is from 20 Hz to 20 KHz. Timbre indicates the unique properties of different sound sources and is determined by the harmonic spectrum and envelope of the sound waveform. In the present disclosure, the clarity of audio may indicate the intelligibility of the audio in a noisy environment, or more specifically, may indicate the frequency components and energy distribution of the background noise in the audio.

In an example of the present disclosure, among the plurality of audio enhancement modes, the first audio enhancement mode can adjust the loudness of the input audio, the second audio enhancement mode can adjust the tone of the input audio, the third audio enhancement mode can adjust the timbre of the input audio, and the fourth audio enhancement mode can adjust the clarity of the input audio, and so on. In another example of the present disclosure, among the plurality of audio enhancement modes, the first audio enhancement mode can adjust both the loudness and tone of the input audio, the second audio enhancement mode can adjust both the tone and timber of the input audio, and the third audio enhancement mode can adjust the loudness, tone, timbre and clarity of the input audio, and so on. In yet another example of the present disclosure, among the plurality of audio enhancement modes, the first audio enhancement mode can perform audio enhancement processing for the features of high-frequency hearing impairment, the second audio enhancement mode can perform audio enhancement processing for the features of low-frequency hearing impairment, and the third audio enhancement mode can perform audio enhancement processing for the features of mixed high- and low-frequency hearing impairment. It should be noted that the above description is merely an example and does not constitute any limitation of the present disclosure. Each of the plurality of audio enhancement modes can adjust any one or more parameters of the input audio, which is not particularly limited by the embodiments of the present disclosure.

The processing unit 404 can, for example, adopt the method described above with reference to FIG. 3 to determine a plurality of audio enhancement modes, but this is not particularly limited by the embodiments of the present disclosure.

When the input audio is an audio to be enhanced output by the terminal, the processing unit 404 can process a part of the input audio using at least one of the plurality of audio enhancement modes to generate at least one processed audio. On the other hand, when the input audio is a test audio output by the terminal, the processing unit 404 can process the entire test audio using at least one of the plurality of audio enhancement modes to generate at least one processed audio. In an example, the processing unit 404 can process the input audio using each of the plurality of audio enhancement modes to generate a plurality of processed audios. In another example, the processing unit 404 can select one or more of the plurality of audio enhancement modes to process the input audio to generate at least one processed audio.

Thereafter, the processing unit 404 can determine a target audio enhancement mode from the plurality of audio enhancement modes based at least in part on the at least one processed audio, where the target audio enhancement mode refers to the audio enhancement mode to be used for audio enhancement processing.

According to an example of an embodiment of the present disclosure, the processing unit 404 can compare the audio qualities of various processed audios, and determine the audio enhancement mode corresponding to the processed audio with the best audio quality as the target audio enhancement mode. The processed audio with the best audio quality can be determined, for example, through subjective evaluation by a user, or through calculation and comparison of objective evaluation parameters of the various processed audios, which is not particularly limited by the embodiments of the present disclosure. For example, the objective evaluation parameters may be the frequency distribution, amplitude, signal-to-noise ratio (SNR), peak-to-average power ratio (PAPR), short-term objective intelligibility (STOI), etc., or any combination thereof, of the processed audio.

According to another example of an embodiment of the present disclosure, the processing unit 404 can compare each of the at least one processed audio with a predetermined condition, and determine the audio enhancement mode corresponding to the processed audio satisfying the predetermined condition as the target audio enhancement mode. For example, one or more thresholds can be preset, such as an amplitude threshold, a frequency distribution related threshold, an SNR threshold, a PANR threshold, an STOI threshold, etc., and when a corresponding parameter of a processed audio is greater than the one or more thresholds, the mode corresponding to the processed audio is determined as the target audio enhancement mode. It should be noted that the description of the threshold here is only an example and does not constitute any limitation of the present disclosure. Any other relevant threshold may also be selected according to actual design or application requirements.

According to yet another embodiment of the present disclosure, the processing unit 404 determines a target audio enhancement mode from the plurality of audio enhancement modes based at least in part on the at least one processed audio, which may further include acquiring an object feature of the object receiving the enhanced audio; and selecting an audio enhancement mode that matches the object feature from the plurality of audio enhancement modes as the target audio enhancement mode. The object receiving the enhanced audio refers to the object that listens to the output enhanced audio, and the object feature may include one or more of the age, gender, hearing ability, personal preference, working environment, living environment, etc., of the object receiving the enhanced audio. The object feature may, for example, be acquired from the user input, or determined by a terminal that applies the audio enhancement method of the present disclosure, such as by facial detection, voiceprint recognition, or other means, which is not particularly limited by the embodiments of the present disclosure. For example, when it is determined that the object receiving the enhanced audio is an elderly person, since the elderly usually have high-frequency hearing impairment, the audio enhancement mode for high-frequency hearing impairment can be determined as the target audio enhancement mode to enhance the high-frequency portion of the input audio. It should be noted that the above description is only an example and does not constitute any limitation of the present disclosure.

The processing unit 404 is configured to process the input audio using the target audio enhancement mode to generate an enhanced audio. As described above, after the target audio enhancement mode is determined, the processing unit 404 can perform audio processing on the input audio and further audios that are input subsequently using the target audio enhancement mode, and thereafter, the output unit 406 can output the generated enhanced audio, for example, to a speaker or other audio playback devices to convey it to the user. The enhanced audio is an audio that is obtained by adjusting one or more of the loudness, tone, timbre, clarity, etc., of the input audio using the target audio enhancement mode for a specific hearing impairment category, so that users who belong to the hearing impairment category or have similar hearing impairment can clearly hear the input audio.

In addition, the audio enhancement apparatus 400 may optionally further include a user interaction unit 408 or more specifically a user interface, which is represented by a dashed box in FIG. 4 and may be configured to display an audio enhancement mode or receive an input of a target audio enhancement mode from a user. In the case where the audio enhancement apparatus is a terminal such as a mobile phone, a tablet computer, a desktop computer, a smart wearable device, earphones, a stereo, a television, etc., with an audio enhancement function, the user interaction unit 408 may be included in the terminal. On the other hand, in the case where the audio enhancement apparatus is an independent apparatus such as earphones or a stereo, the user interaction unit 408 may be included in a terminal such as a mobile phone, a tablet computer, a desktop computer, a smart wearable device, earphones, a stereo, a television, etc., which is connected to the user interaction unit 408 via Bluetooth, WiFi, etc.

FIG. 5 illustrates a user interface according to an example of one or more embodiments of the present disclosure. In the example of FIG. 5, the user interface can display various audio enhancement modes (M ode 1 to M ode N shown in the figure). For example, it can respectively display the audio enhancement mode that is currently processing, and play the processed audio to the user. Furthermore, the user can also manually select or switch to any audio enhancement mode through the user interface to enhance the input audio. In some cases, when the user clearly knows the required audio enhancement mode, he/she can select the target audio enhancement mode directly from the plurality of audio enhancement modes. For example, elderly users can directly select an audio enhancement mode for elderly people with hearing impairments through the user interface.

By using the audio enhancement apparatus according to one or more embodiments of the present disclosure, it is possible to objectively divide a plurality of hearing impairment categories through big data analysis of the hearing test data and formulate a plurality of audio enhancement modes specifically for them. Therefore, when the input audio is enhanced using the target audio enhancement mode determined from the plurality of audio enhancement modes, the hearing defects of users with hearing impairments can be better compensated for, thereby providing users with a better auditory experience.

In one or more embodiments of the present disclosure, an audio enhancement device is further provided, which includes one or more processors and one or more memories, where the one or more memories have computer-readable instructions stored therein, the computer-readable instructions, when executed by the one or more processors, cause the one or more processors to perform the audio enhancement method as described above.

The embodiments of the present disclosure may also be implemented as a computer-readable storage medium. The computer-readable storage medium according to the embodiments of the present disclosure has computer-readable instructions stored thereon. The computer-readable instructions, when executed by a processor, can perform the audio enhancement method according to the embodiments of the present disclosure described with reference to the drawings above. The computer-readable storage medium includes, but is not limited to, for example, a volatile memory and/or nonvolatile memory. The volatile memory may include, for example, a random access memory (RAM) and/or a cache memory (cache), and the like. The non-volatile memory may include, for example, a read-only memory (ROM), a hard disk, a flash memory, and the like.

According to an embodiment of the present disclosure, a computer program product or a computer program is further provided. The computer program product or the computer program includes computer-readable instructions, and the computer-readable instructions are stored in a computer-readable storage medium. The processor of the computer device can read the computer-readable instructions from the computer-readable storage medium, and the processor executes the computer-readable instructions to cause the computer device to perform the audio enhancement method described in the above embodiments.

The program portion of the technology may be considered as a “product” or “artifact” existing in the form of executable codes and/or associated data, which is engaged or implemented through a computer-readable medium. A tangible, permanent storage medium may include the memory or storage used in any computer, processor, or similar device or related module. For example, various semiconductor memories, tape drives, disk drives, or any similar devices capable of providing storage functions for software.

All of the software or portions thereof may from time to time communicate over a network, such as the Internet or other communications networks. Such communication may load software from one computer device or processor to another. For example, loading from one server or host of the device to one hardware platform of a computing environment, or another computing environment implementing the system, or a system of similar functionality related to providing required information. Therefore, another medium capable of transferring software elements may also be used as a physical connection between local devices, such as light wave, radio wave, electromagnetic wave, etc., which are propagated through cables, optical cables, or air. The physical medium used to carry waves, such as cables, wireless links, optical cables and the like devices, may also be considered a medium for carrying the software. As used herein, unless restricted to tangible “storage” media, other terms referring to computer or machine “readable media” refer to media that participate in the process of a processor executing any instructions.

The present application uses specific words to describe embodiments of the present application. For example, “first/second embodiment”, “an embodiment”, and/or “some embodiments” means a feature, structure, or characteristic associated with at least one embodiment of the present application. Accordingly, it should be emphasized and noted that “an embodiment” or “one embodiment” or “an alternative embodiment” referred to two or more times in different places in this specification does not necessarily refer to the same embodiment. In addition, certain features, structures, or characteristics of one or more embodiments of the present application may be combined as appropriate.

In addition, it can be understood by those skilled in the art that aspects of the present application may be illustrated and described by a number of patentable categories or circumstances, including any new and useful process, machine, product, or combination of substances, or any new and useful improvement thereof. Accordingly, aspects of the present application may be performed entirely by hardware, may be performed entirely by software (including firmware, resident software, microcode, or the like), or may be performed by a combination of hardware and software. All of the above hardware or software may be referred to as “data blocks”, “modules”, “engines”, “units”, “components” or “systems”. Additionally, aspects of the present application may be manifested as a computer product disposed in one or more computer-readable media, the product including computer-readable program code.

Unless otherwise defined, all terms used herein, including technical and scientific terms, have the same meaning as commonly understood by those of ordinary skill in the art It should also be understood that terms such as those defined in common dictionaries should be construed as having a meaning consistent with their meaning in the context of the relevant technology and should not be construed with idealized or extremely formalized meanings unless expressly defined as such herein.

The foregoing is a description of the present inventive concepts and should not be considered a limitation thereof. Although several exemplary embodiments of the present inventive concepts are described, it will be readily understood by those skilled in the art that many modifications can be made to the exemplary embodiments without departing from the novel teachings and advantages of the present inventive concepts. Accordingly, all such modifications are intended to be encompassed within the scope of the present inventive concepts as defined by the claims. It should be understood that the foregoing is a description of the present inventive concepts and should not be considered to be limited to the particular embodiments as disclosed, and that modifications to the disclosed embodiments, as well as other embodiments, are intended to be included within the scope of the appended claims. The present inventive concepts are defined by the claims and equivalents thereof.

What is claimed is:

1. A computer-implemented method for audio enhancement, comprising:
receiving an input audio;
processing at least a part of the input audio using at least one of a plurality of audio enhancement modes to generate at least one processed audio;
determining a target audio enhancement mode from the plurality of audio enhancement modes based at least in part on the at least one processed audio;
processing the input audio using the target audio enhancement mode to generate an enhanced audio; and
outputting the enhanced audio.

2. The computer-implemented method of claim 1, wherein each of the plurality of audio enhancement modes is used to adjust one or more of loudness, tone, timbre, or clarity of the input audio.

3. The computer-implemented method of claim 1, wherein the plurality of audio enhancement modes are predetermined by:
determining a plurality of hearing impairment categories based on hearing test data, wherein the plurality of hearing impairment categories are determined based on hearing responses for one or more of loudness, tone, timbre or clarity;
determining one or more acoustic adjustment parameters for each of the plurality of hearing impairment categories by analyzing the hearing responses, the acoustic adjustment parameters being used for adjusting one or more of the loudness, the tone, the timbre, or the clarity; and
determining an audio enhancement mode corresponding to each of the plurality of hearing impairment categories based on the one or more acoustic adjustment parameters.

4. The computer-implemented method of claim 1, wherein determining the target audio enhancement mode from the plurality of audio enhancement modes based at least in part on the at least one processed audio comprises:
determining an audio enhancement mode corresponding to a processed audio with a best audio quality among the at least one processed audio as the target audio enhancement mode.

5. The computer-implemented method of claim 1, wherein determining the target audio enhancement mode from the plurality of audio enhancement modes based at least in part on the at least one processed audio comprises:
comparing the at least one processed audio with a predetermined condition; and
determining an audio enhancement mode corresponding to a processed audio satisfying the predetermined condition among the at least one processed audio as the target audio enhancement mode.

6. The computer-implemented method of claim 1, wherein determining the target audio enhancement mode from the plurality of audio enhancement modes based at least in part on the at least one processed audio comprises:
acquiring an object feature of an object receiving the enhanced audio; and
selecting an audio enhancement mode that matches the object feature from the plurality of audio enhancement modes as the target audio enhancement mode.

7. The computer-implemented method of claim 6, wherein the object feature includes one or more of age, gender, hearing ability, personal preference, working environment, or living environment of the object receiving the enhanced audio.

8. An audio enhancement apparatus, comprising:
a receiving unit configured to receive an input audio;
a processing unit configured to:
process at least a part of the input audio using at least one of a plurality of audio enhancement modes to generate at least one processed audio,
determine a target audio enhancement mode from the plurality of audio enhancement modes based at least in part on the at least one processed audio, and
process the input audio using the target audio enhancement mode to generate an enhanced audio; and
an output unit configured to output the enhanced audio.

9. The audio enhancement apparatus of claim 8, wherein each of the plurality of audio enhancement modes is used to adjust one or more of loudness, tone, timbre, or clarity of the input audio.

10. The audio enhancement apparatus of claim 8, wherein the plurality of audio enhancement modes are predetermined by:
determining a plurality of hearing impairment categories based on hearing test data, wherein the plurality of hearing impairment categories are determined based on hearing responses for one or more of loudness, tone, timbre or clarity;
determining one or more acoustic adjustment parameters for each of the plurality of hearing impairment categories by analyzing the hearing responses, the acoustic adjustment parameters being used for adjusting one or more of the loudness, the tone, the timbre, or the clarity; and
determining an audio enhancement mode corresponding to each of the plurality of hearing impairment categories based on the one or more acoustic adjustment parameters.

11. The audio enhancement apparatus of claim 8, wherein determining the target audio enhancement mode from the plurality of audio enhancement modes based at least in part on the at least one processed audio comprises:
determining an audio enhancement mode corresponding to a processed audio with a best audio quality among the at least one processed audio as the target audio enhancement mode.

12. The audio enhancement apparatus of claim 8, wherein determining the target audio enhancement mode from the plurality of audio enhancement modes based at least in part on the at least one processed audio comprises:
comparing the at least one processed audio with a predetermined condition; and
determining an audio enhancement mode corresponding to a processed audio satisfying the predetermined condition among the at least one processed audio as the target audio enhancement mode.

13. The audio enhancement apparatus of claim 8, wherein determining the target audio enhancement mode from the plurality of audio enhancement modes based at least in part on the at least one processed audio comprises:
acquiring an object feature of an object receiving the enhanced audio; and
selecting an audio enhancement mode that matches the object feature from the plurality of audio enhancement modes as the target audio enhancement mode.

14. The audio enhancement apparatus of claim 13, wherein the object feature includes one or more of age, gender, hearing ability, personal preference, working environment, or living environment of the object receiving the enhanced audio.

15. One or more non-transitory computer-readable media storing instructions that, when executed by one or more processors, cause the one or more processors to perform the steps of:
receiving an input audio;
processing at least a part of the input audio using at least one of a plurality of audio enhancement modes to generate at least one processed audio;
determining a target audio enhancement mode from the plurality of audio enhancement modes based at least in part on the at least one processed audio;
processing the input audio using the target audio enhancement mode to generate an enhanced audio; and
outputting the enhanced audio.

16. The one or more non-transitory computer-readable media of claim 15, wherein each of the plurality of audio enhancement modes is used to adjust one or more of loudness, tone, timbre, or clarity of the input audio.

17. The one or more non-transitory computer-readable media of claim 15, wherein the plurality of audio enhancement modes are predetermined by:
determining a plurality of hearing impairment categories based on hearing test data, wherein the plurality of hearing impairment categories are determined based on hearing responses for one or more of loudness, tone, timbre or clarity;
determining one or more acoustic adjustment parameters for each of the plurality of hearing impairment categories by analyzing the hearing responses, the acoustic adjustment parameters being used for adjusting one or more of the loudness, the tone, the timbre, or the clarity; and
determining an audio enhancement mode corresponding to each of the plurality of hearing impairment categories based on the one or more acoustic adjustment parameters.

18. The one or more non-transitory computer-readable media of claim 15, wherein determining the target audio enhancement mode from the plurality of audio enhancement modes based at least in part on the at least one processed audio comprises:
determining an audio enhancement mode corresponding to a processed audio with a best audio quality among the at least one processed audio as the target audio enhancement mode.

19. The one or more non-transitory computer-readable media of claim 15, wherein determining the target audio enhancement mode from the plurality of audio enhancement modes based at least in part on the at least one processed audio comprises:
comparing the at least one processed audio with a predetermined condition; and
determining an audio enhancement mode corresponding to a processed audio satisfying the predetermined condition among the at least one processed audio as the target audio enhancement mode.

20. The one or more non-transitory computer-readable media of claim 15, wherein determining the target audio enhancement mode from the plurality of audio enhancement modes based at least in part on the at least one processed audio comprises:
acquiring an object feature of an object receiving the enhanced audio; and
selecting an audio enhancement mode that matches the object feature from the plurality of audio enhancement modes as the target audio enhancement mode.
